(19) United States
(12) Patent Application Publication
(10) Pub. No.: US 2006/0096112 A1
(43) Pub. Date: May 11, 2006

(54) Construction measuring tape

(76) Inventor: Jeffrey J. Berring, Canton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/268,111

(22) Filed: Nov. 7, 2005

Related U.S. Application Data
(60) Provisional application No. 60/626,307, filed on Nov. 9, 2004.

(51) Int. Cl. G01B 3/10

(52) U.S. Cl. 33/759

(57) ABSTRACT

A construction measuring tape for assisting in correct positioning of construction members including applying a plurality of series of repeating indicia onto one of the upper and lower surfaces of a non-stretch adhesive tape. The indicia include first markers marked at equal and repeating first intervals along the length of the tape; second markers marked at equal and repeating second intervals along the length of the tape and third markers marked at equal and repeating third intervals along the length of the tape. The first intervals are smaller than the second intervals which are, in turn, smaller than the third intervals. At least one on of the first, second and third markers are marked in a color on the tape and one of the other of the first, second and third markers is marked in a second and different color. The tape is also marked with pairs of linear markers around each of the second and third markers. The linear markers lie at right angles to the longitudinal axis of the tape. The linear markers are made in the same color as the second or third marker around which they are positioned.

### CROSS REFERENCE TO RELATED APPLICATIONS

This application claims priority from U.S. Provisional Application Ser. No. 60/626,307 filed Nov. 9, 2004; the disclosure of which is incorporated herein by reference.

### BACKGROUND OF THE INVENTION

1. Technical Field

This invention generally relates to a construction measuring tape. More particularly, the invention relates to an adhesive measuring tape which is applied to a surface to indicate accurate placement of construction members. Specifically, the invention relates to a construction measuring tape which has both color-coding and numerical indicia thereon as well as positioning guides for indicating the accurate placement of at least two different types of construction members on different centers.

2. Background Information

One of the problems experienced by builders when they are framing walls for houses and other structures, is that studs and joists have to be accurately positioned at regular intervals in order to provide a predictable nailing surface for sheet materials such as drywall. When framing a wall section, for example, all vertical studs must be positioned at 16″ centers. Roof joists, on the other hand, have to be positioned at 24″ centers. Typically, builders have marked the positions of the centers in a number of ways. When a carpenter wishes to frame a wall, he places the top plate and bottom plate on top of each other, ensuring that the ends of the top and bottom plate are aligned. Sometimes, the top and bottom plates are nailed together to prevent them from moving relative to each other. The center of the first stud is then marked on both the top and bottom plate using a pencil and then the carpenter measures the appropriate distance, i.e., 16″, to the center of the next stud and then 16″ to the center of the next stud and so on. Problems arise because the carpenter may hook a measuring tape at one end of the top or bottom plate to mark the position of the first stud and may forget to move the end of the measuring tape to the center of the first stud before he measures the 16″ for the next stud. As a result of this inadvertent error, the center of the second stud is marked incorrectly and the error is continued for the rest of the wall. The carpenter needs to double-check the measuring and this involves repeatedly pulling out the tape measure and checking the dimensions and centers of the studs. This entire method involves the potential for making errors.

The problem has been addressed in the prior art by producing an adhesive tape that is applied to the top plate and bottom plate. The adhesive tape includes a plurality of markings on it for placement of construction members such as studs.

A first patent disclosing one such tape is U.S. Pat. No. 4,149,320, issued to Troyer et al. This tape has numbers on it to mark distances and has coded shapes, such as rectangles or triangles, cut into the tape to indicate the position where construction members should be positioned. A second embodiment may include the word “stud” and “roof” to indicate locations for positioning members. The indicia on the tape may be color coded.

A second patent disclosing such an adhesive tape is U.S. Pat. No. 4,367,590, issued to Winter et al. This tape again has transverse lines and numbers indicating distance along the tape and has a cross-hatched area indicating the position for location of a stud. The tape also includes perforations running along the longitudinal axis of the tape.

A third patent disclosing an adhesive construction tape is U.S. Pat. No. 4,845,858, which includes differently colored bands to indicate different distances between centers along the length of the tape. Where distances between centers overlap, the colored bands overlap.

While the above patents do disclose an adhesive tape that is marked to indicate distances between centers of construction members, the previously known tapes have not always been easy to read inasmuch as the coding for the various centers must be remembered or it was difficult to determine where the stud or joist should actually be positioned.

There is therefore a need in the art for an adhesive tape that clearly distinguishes between the different distances possible between centers of construction members, makes it easy to read the tape and clearly indicates the position for locating the construction member.

### SUMMARY OF THE INVENTION

A construction measuring tape for assisting in correct positioning of construction members including applying a plurality of series of repeating indicia onto one of the upper and lower surfaces of a non-stretch adhesive tape. The indicia include first markers marked at equal and repeating first intervals along the length of the tape; second markers marked at equal and repeating second intervals along the length of the tape and third markers marked at equal and repeating third intervals along the length of the tape. The first intervals are smaller than the second intervals which are, in turn, smaller than the third intervals. At least one on of the first, second and third markers are marked in a color on the tape and one of the other of the first, second and third markers is marked in a second and different color. The tape is also marked with pairs of linear markers around each of the second and third markers. The linear markers lie at right angles to the longitudinal axis of the tape. The linear markers are made in the same color as the second or third marker around which they are positioned.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a side view of a roll of adhesive tape in accordance with the present invention;

FIG. 1A is a cross-sectional end view of the tape of FIG. 1;

FIG. 2 is a top view of the adhesive tape in accordance with the present invention;

FIG. 2A is a magnified top view of the first section of the tape shown in FIG. 2;

FIG. 2B is a magnified top view of the middle section of the tape shown in FIG. 2;

FIG. 2C is a magnified top view of the third section of the tape shown in FIG. 2;

FIG. 3 is a side view of a top plate and bottom plate and the adhesive tape to be attached thereto;

FIG. 4 is top view of the adhesive tape positioned on a construction member and showing a center longitudinal line;

FIG. 5 is a top view of the adhesive tape positioned on a construction member and showing the tape being separated into two strips;

FIG. 6 is a side view of the two separated strips of adhesive tape positioned on a spaced apart top plate and bottom plate;

FIG. 7 is a side view of the separated top and bottom plate of FIG. 6 being connected together by construction members positioned with the aid of the strips of construction tape;

FIG. 8 is a perspective view of the tape applied to the upper surface of a top plate and roof trusses being positioned according to the markings on the tape;

FIG. 9 is a perspective view of the roof trusses secured into place along top plate and showing the tape remaining in position on the top plate;

FIG. 10 is a top view showing how to align the sides of a truss with the indicators on the tape; and showing placement of a second truss the appropriate distance from the first truss;

FIG. 11 is perspective view showing a series of floor joists being aligned with markings on the adhesive tape;

FIG. 12 is a perspective view showing the floor joists secured in place and the adhesive tape remaining in place;

FIG. 13 is a top view showing how to align the sides of the floor joists with the indicators on the tape and showing correct placement of a second floor joist the appropriate distance from the floor joist;

FIG. 14 is a perspective view showing the adhesive tape placed on the outside of house wrap for use in locating studs when securing siding;

FIG. 15 is a top view showing use of the tape for positioning other types of construction members; and

FIG. 16 is a schematic side view showing the tape being printed by two side-by-side print rollers.

Similar numbers refer to similar parts throughout the specification.

### DETAILED DESCRIPTION OF THE INVENTION

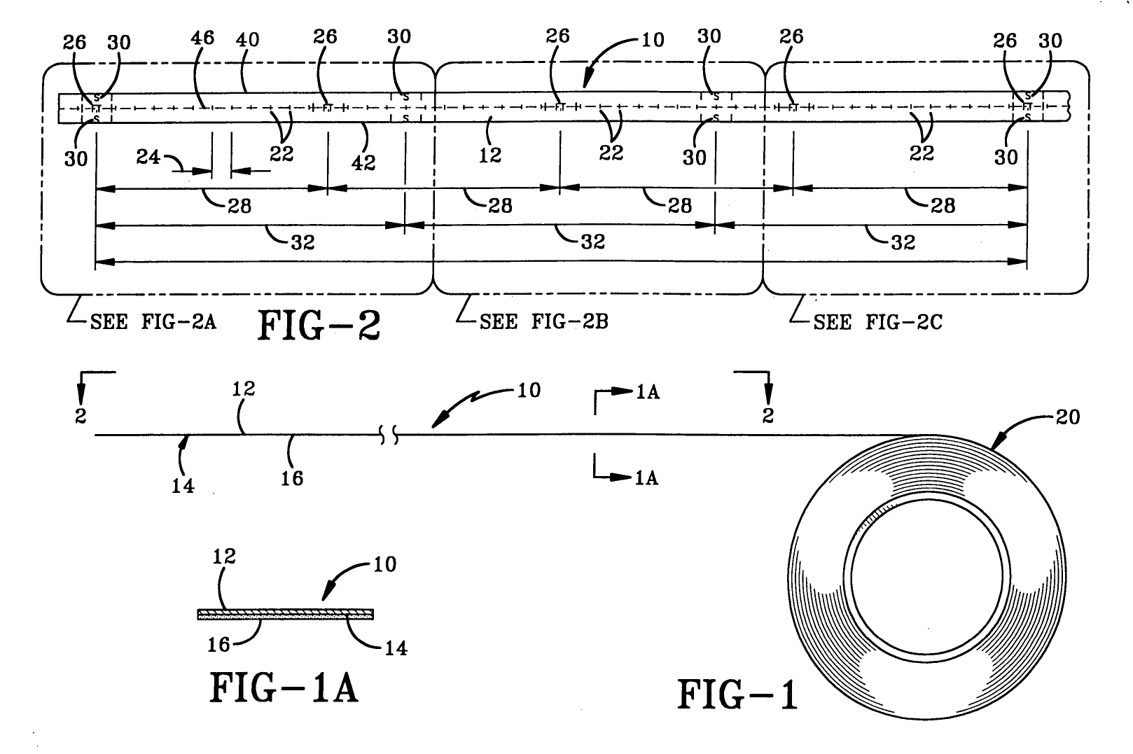

Referring to FIGS. 1-1A there is shown a construction measuring tape in accordance with the present invention and generally indicated at 10. Tape 10 has an upper surface 12 and a lower surface 14. Lower surface 14 is coated with an adhesive layer 16 for attaching tape 10 to a construction member such as a top plate or bottom plate (not shown in these figures). Tape 10 is formed into a roll 20 for easy use on the construction site.

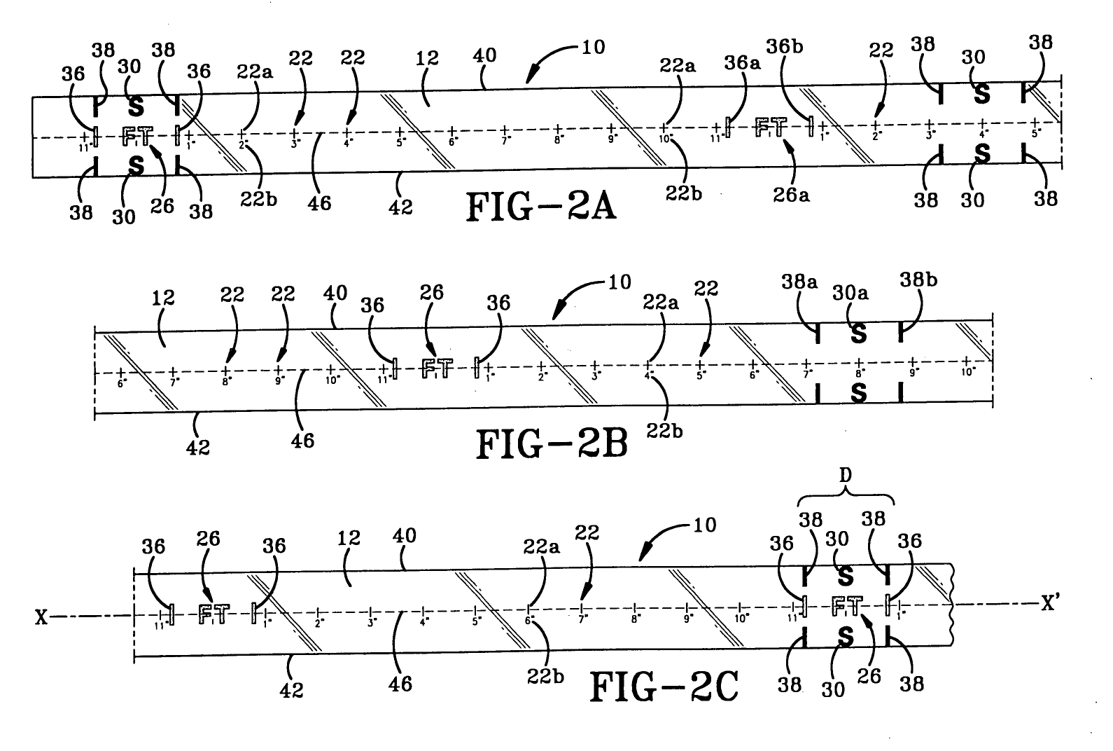

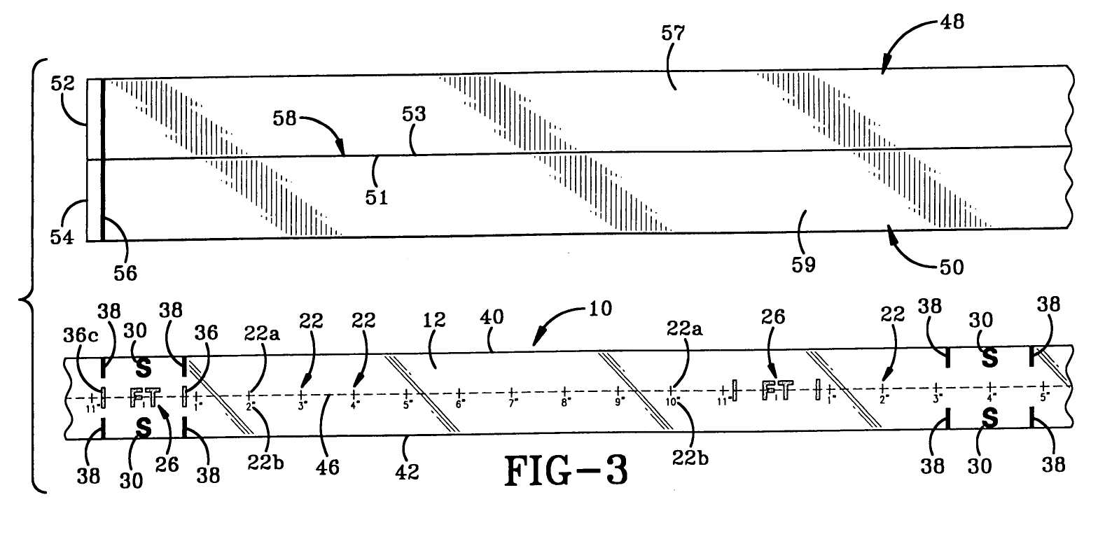

Referring to FIGS. 2-2C, tape 10 is manufactured from a non-stretch or low-stretch material and preferably is transparent. In accordance with the present invention, a plurality of different indicia are marked at repeating intervals on upper surface 12 of tape 10. These indicia include a plurality of first markers 22 which are spaced apart from each other at a first interval 24 or distance along the length of tape 10 (FIG. 2). In the preferred embodiment of the invention, first interval 24 is one inch long. First markers 22 include at least a short line or line-portion 22a and preferably also include a number-portion 22b (FIG. 2A). The numbers can start at “0” and continue increasing by one, i.e., “0, 1, 2, 3, 4, 5, 6 . . . ” In the preferred embodiment of the invention, the numbers start at “1” and increase up to the number “11”. Every twelfth inch, i.e. every one foot, the first marker 22 comprises only the small line and the number is replaced with a second marker 26. Second markers 26 therefore mark off a second interval 28 of one foot. Second markers 26 preferably are marked on upper surface 12 in a first color, such as the color red. In the preferred embodiment of the invention, second markers 26 comprise the letters “FT” which represent the word “foot”. A first linear marker 36 is positioned on either side of each second marker 26 (FIG. 2A). First linear markers 36 lie substantially at right angles to the longitudinal axis of tape 10 and preferably are marked in the same color as second markers 26. The distance between the first linear markers of each pair of parallel first linear markers 36 is substantially equal to the width of a 2″×4″ stud. Consequently, as may be seen in FIG. 2A, each second marker 26a for example, lies substantially in the middle of a pair of linear markers 36a and 36b.

A plurality of third markers 30 are also marked on upper surface 12 of tape 10. Third markers 30 are spaced a third interval 32 apart from each other. Third interval 32 is sixteen inches long—the standard distance used for positioning studs when framing walls. Third markers 30 preferably are marked in a second color, such as blue, or any other color different to the first color of second markers 26. In the preferred embodiment of the invention, third markers 30 comprise the letter “S” which represents the word “stud”. A pair of second linear markers 38 are provided around each third marker 30. Second linear markers 38 lie substantially at right angles to the longitudinal axis of tape 10 and are marked on upper surface 12 in the same color as third markers 30. So, for example in FIG. 2B, third marker 30a lies substantially in the middle of the pair of parallel second linear markers 38a and 38b. The distance between second linear markers 38a and 38b is substantially equal to the width of a 2″×4″ construction member (not shown). Both first and second linear markers 36, 38 preferably are short lines or dashes. At least one of the pairs of each of first and second linear markers 36, 38 may, however, be a continuous line extending from one edge 40 of tape to the other edge 42.

In the preferred embodiment of the invention, first markers 22 and second markers 26 are marked proximate the midline X-X′ of tape 10. With respect to first markers 22, the line-portion 22a of each first marker 22 crosses the midline X-X′ of tape 10 and the number-portion 22b of each first marker 22 lies on one side of the midline X-X′. Third markers 30 are marked a distance from midline X-X′ and proximate edges 40 and 42 of tape 10. First linear markers 36 are positioned near second markers 26 and cross midline X-X′ of tape 10. Second linear markers 38 are positioned proximate third markers 30, away from midline X-X′ and proximate edges 40, 42 of tape 10.

Every four feet along the length of tape 10, the second markers 26 and third markers 30 fall in exactly the same place (FIG. 2C). When this occurs, both second and third markers 26, 30, along with first and second linear markers 36, 38, are marked on tape 10 in the manner shown in area “D” of FIG. 2C. The differences in the color of the markers and the use of the easily understood symbols, namely “FT” and “S”, makes the tape easily readable and usable. Furthermore, it should be noted that first markers 22 are much smaller in size than either second and/or third markers 26, 30. This size difference enhances the readability of tape 10 as it makes tape 10 appear less cluttered and consequently a carpenter can readily see the more frequently used second and third markers 26, 30 for positioning studs, roof trusses and other construction members. When smaller measurements are needed for positioning construction members, then the carpenter will use the first members 22.

Tape 10 preferably also includes a plurality of perforations 46 along midline X-X′ along which tape 10 may be separated into two substantially equal halves.

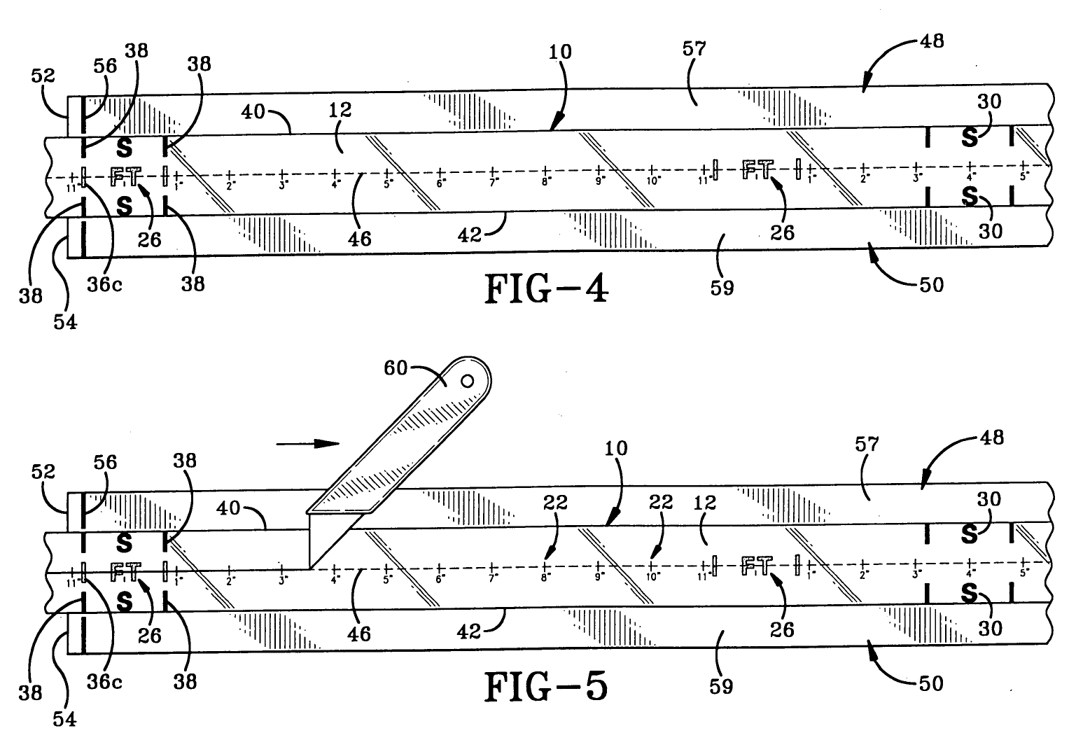

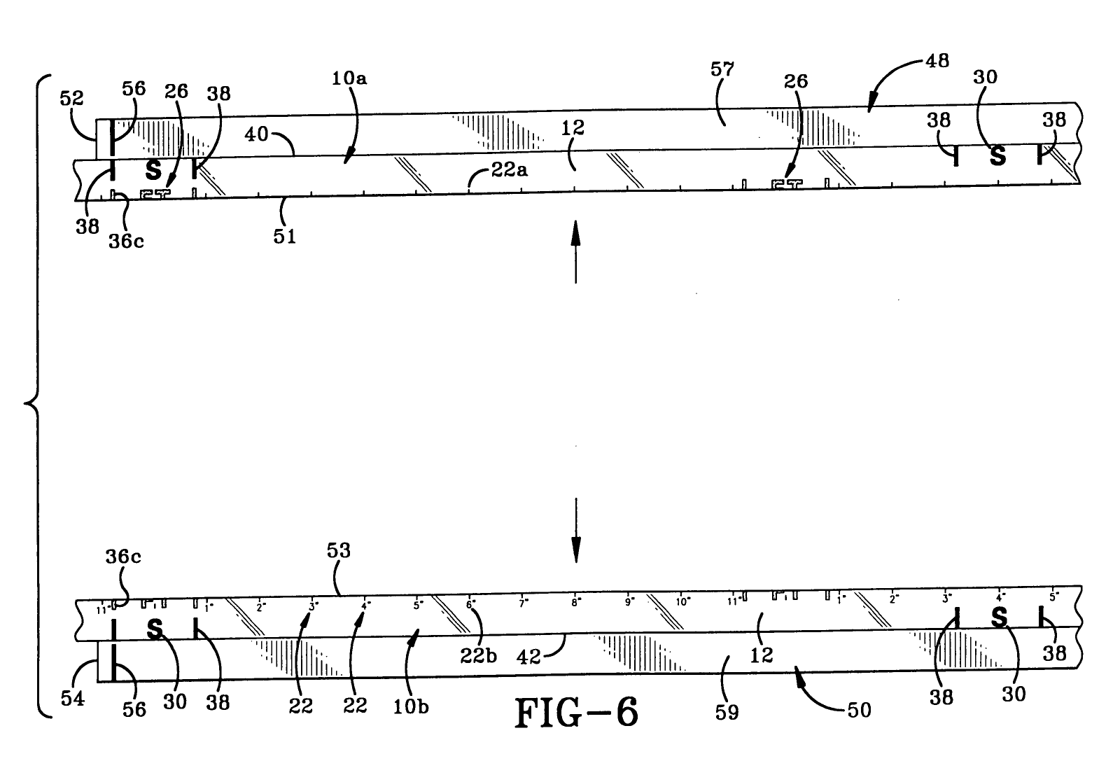

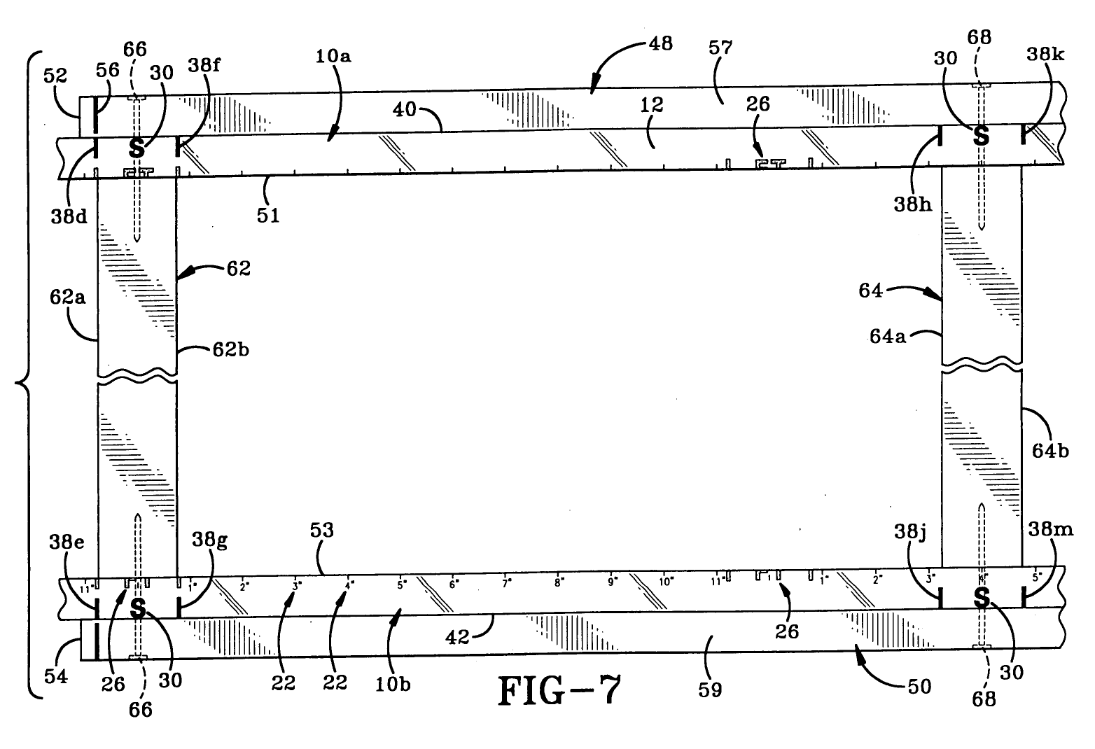

Referring to FIGS. 3-7, tape 10 is used in the following manner to frame a wall. A top plate 48 and bottom plate 50 are placed one on top of the other with at least their first ends 52, 54 aligned and the lower surface 51 of top plate 48 in contact with the upper surface 53 of bottom plate 50. Top and bottom plate 48, 50 may be temporarily secured together by a suitable means, such as nailing (not shown). The carpenter works out the desired position of a first side of a first stud relative to ends 52, 54 of top and bottom plates 48, 50. That position is marked by drawing a line 56 on sides 57, 59 of plates 48, 50. Tape 10 is then aligned to top and bottom plates 48, 50 by aligning first linear marker 36c with line 56 and aligning perforations 46 along the contact-line 58 between the lower and upper surfaces 51, 53 of top and bottom plates 48, 50. Tape 10 is then secured to top and bottom plates 48, 50 by pushing the adhesive on the underside of tape 10 into contact with plates 48, 50. Tape 10 may then be divided along perforations 46 by means of a utility knife 60. Top plate 48 and bottom plate 50 are then separated (FIG. 6) leaving a first segment 10a of tape 10 attached to top plate 48 and a second segment 10b of tape 10 attached to bottom plate 50. Both first and second segments 10a, 10b including indicia to show the carpenter where to locate various construction members. As may be seen from FIG. 7, studs 62, 64 may be connected between top and bottom plates 48, 50. A first side 62a of stud 62 is lined up with second linear marker 38d of segment 10a of tape 10. At the same time first side 62a of stud 62 is lined up with second linear marker 38e of segment 10b of tape 10. Second side 62b of stud 62 simultaneously lines up with second linear marker 38f of segment 10a and second linear marker 38g of segment 10b. Stud 62 is secured into top and bottom plates 48, 50 by screws 66. In a similar fashion, stud 64 is secured between top and bottom plates by aligning first side 64a of stud 64 with second linear markers 38h and 38j; and second side 64b of stud 64 with second linear markers 38k and 38m. Second stud 64 is secured to top and bottom plates 48, 50 by screws 68. This procedure is repeated until studs are secured along entire length of top and bottom plates 48, 50.

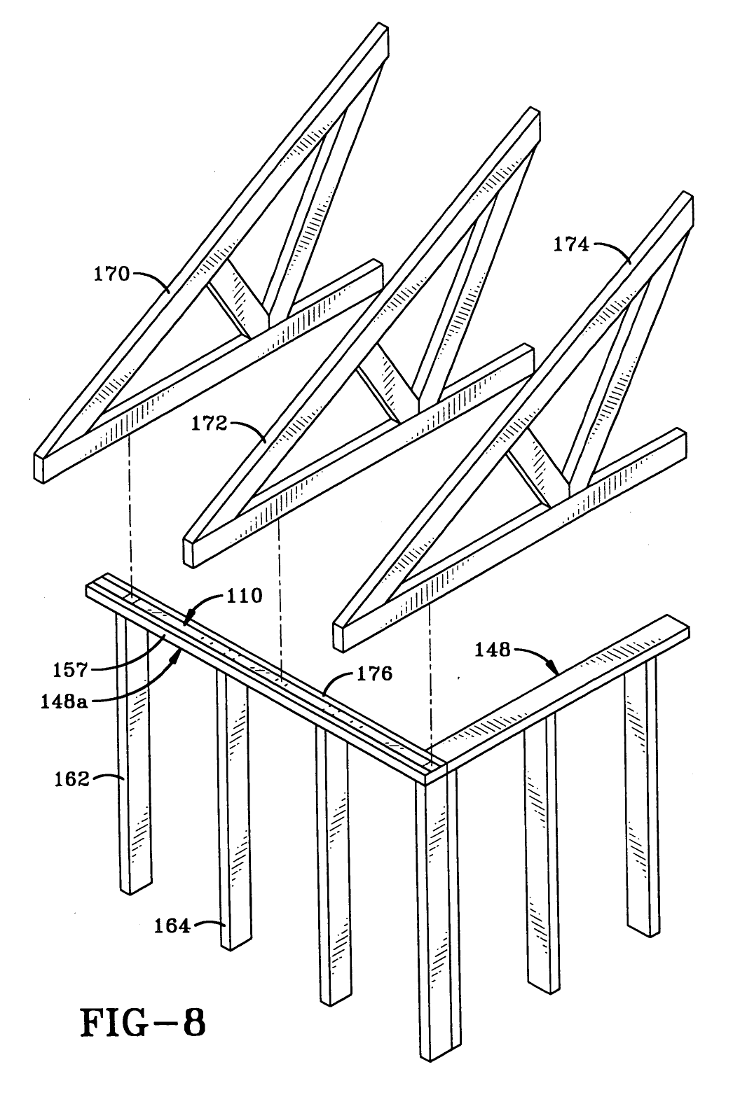

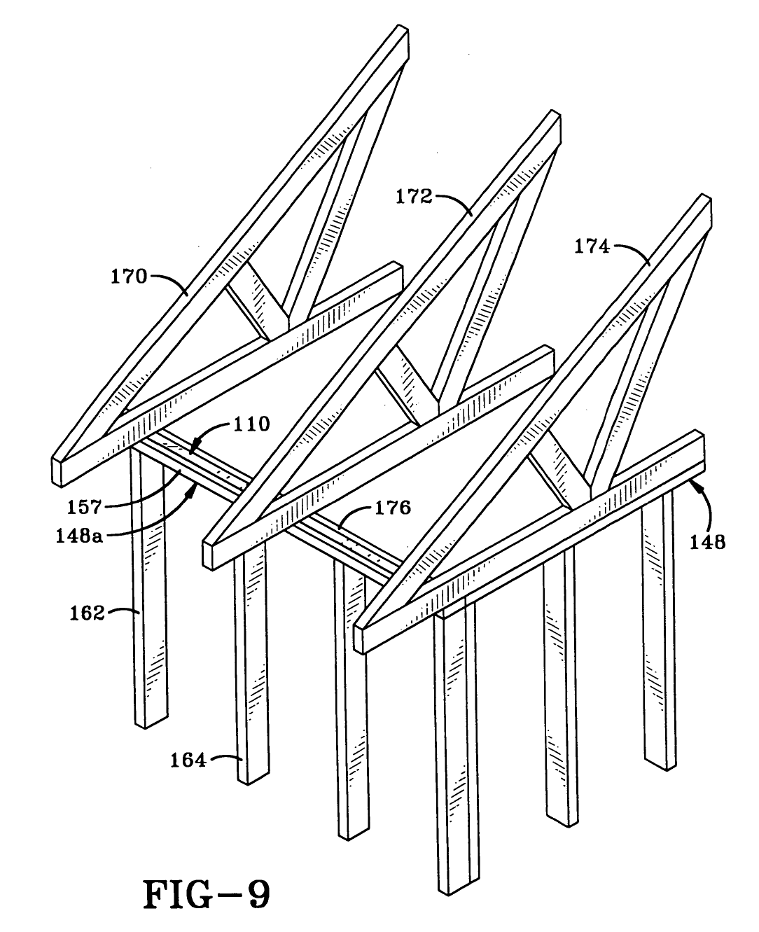

Referring to FIGS. 8-10, construction measuring tape, generally indicated at 110, may be used to assist a carpenter to position roof trusses 170, 172, 174 along a top plate 148a of a framed wall. It will be understood that the opposite ends of the trusses are similarly connected to another remote top plate which lies substantially parallel to top plate 148a but is not shown in the attached figures. In order to install trusses 170, 172 and 174, the carpenter predetermines the position of truss 170 and then adhesively attaches tape 110 to the upper surface 176 of top plate 148a. This means that first linear markers 136 of second marker 126a on tape 110 will be positioned to lie in the correct position along top plate 148a to be aligned with the sides 170a, 170b of truss 170 (FIG. 10). In order to secure truss 170 in the correct place on top plate 148a, sides 170, 170b of truss 170 are aligned with first linear markers 136 of second marker 126a. Truss 170 is then secured to top plate 148a by conventional means. When building a roof, the trusses are separated from each other by a distance of two feet and the rafters can be at a distance of 16″ from each other. The carpenter therefore skips the next second marker 126b and aligns the sides 172a, 172b of the truss 172 with the first linear markers 136 of second marker 126c. Truss 172 is secured in place to top plate 148 by conventional means. The carpenter skips the next second marker (not shown) and positions truss 174 on the next following second marker (not shown) in the same manner. Truss 174 is then secured to top plate 148 by conventional means. All additional roof trusses are installed in a similar manner. Although it is not shown in these figures, it will be understood that construction measuring tape 10 may have been used along the side 157 of top plate 148a for aid in installation of studs 162 and 164.

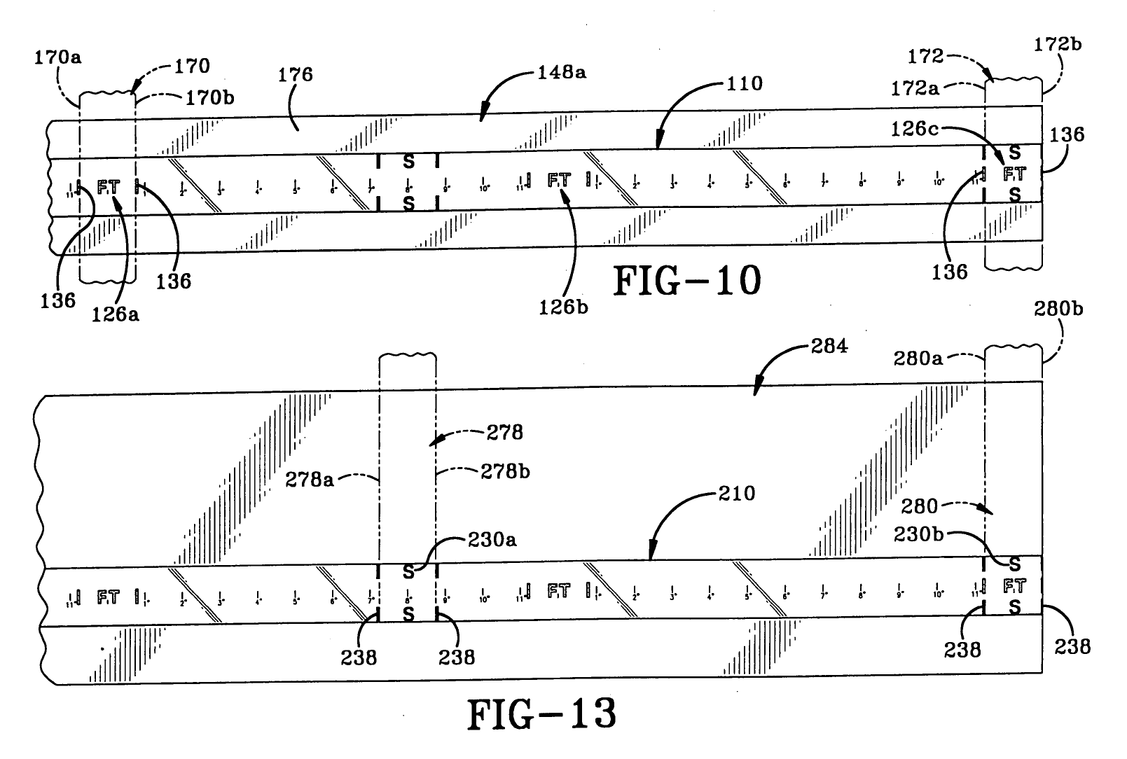

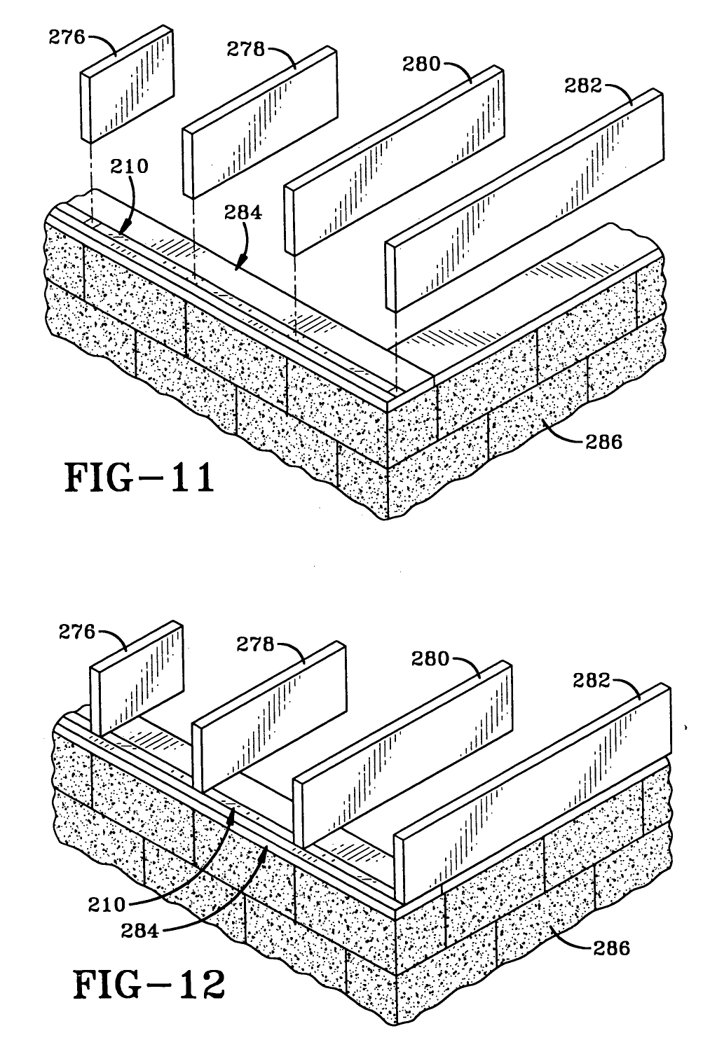

Referring to FIGS. 11-13, construction measuring tape, generally indicated at 210 may be used to position floor joists 276, 278, 280, 282 onto a base board 284 attached to a foundation 286. It will be understood that while only one base board 284 is shown in the attached figures, that the opposite ends of the floor joists are connected to a second remote base board in a similar manner. Floor joists are mounted at intervals of sixteen inches along base board 284. Tape 210 is attached to base board 284 to ensure that the first joist is positioned correctly. When joist 278 is installed, the sides 278a and 278b of joist 278 are aligned with the second linear markers 238 of third marker 230a. Joist 278 is then secured to base board 284 by conventional means. Joist 280 is then installed on base board 284 by aligning the sides 280a and 280b of joist 280 with second linear markers 238 of third marker 230b and securing it in place by conventional means. The next joist 282 is positioned at the next third marker (not shown) along tape 210 in a similar manner and is again secured to base board 284 by conventional means. This procedure is repeated until all the floor joists are secured in place.

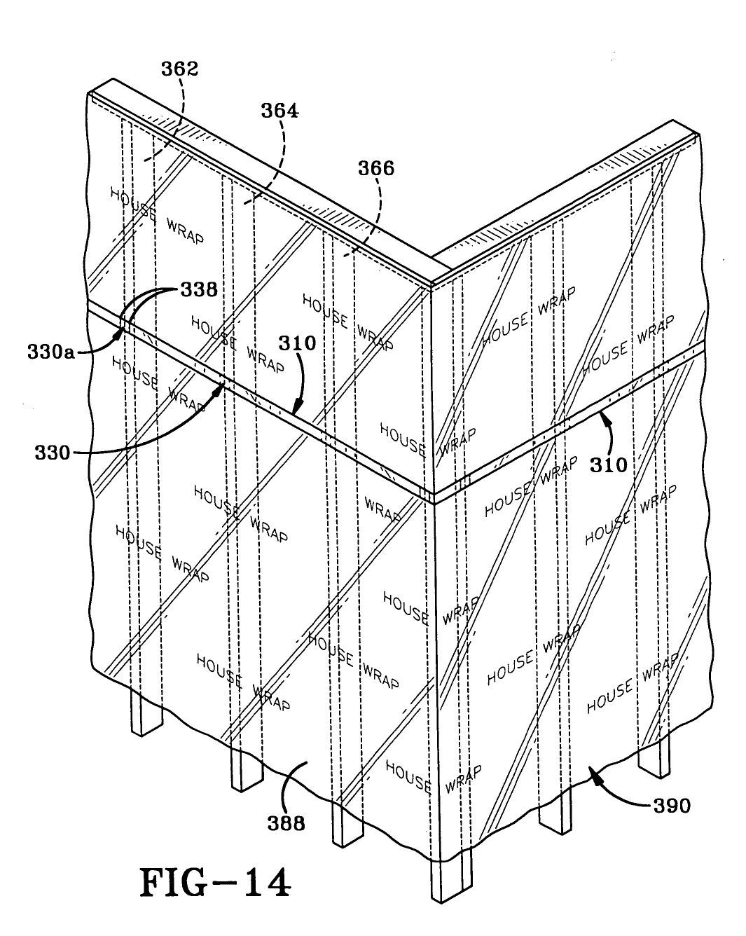

Referring to FIG. 14, construction measuring tape, generally indicated at 310, may be applied to the outer surface 388 of a finished wall 390 to aid in correct positioning of construction members such as siding (not shown). In this instance, the carpenter marks the position of the first stud 362 on the outer surface 388 of wall 390. The carpenter then attaches tape 310 to outer surface 388 making sure that third marker 330a and its corresponding second linear markers 338a accurately indicate the position of stud 362. Tape 310 is then drawn across outer surface 388 of wall 390 so that the positions of the remaining studs, 364, 366, for example, can be accurately indicated. The siding (not shown) can then be installed using tape 310 as a guide to the correct positions of all the studs 362, 364, 366.

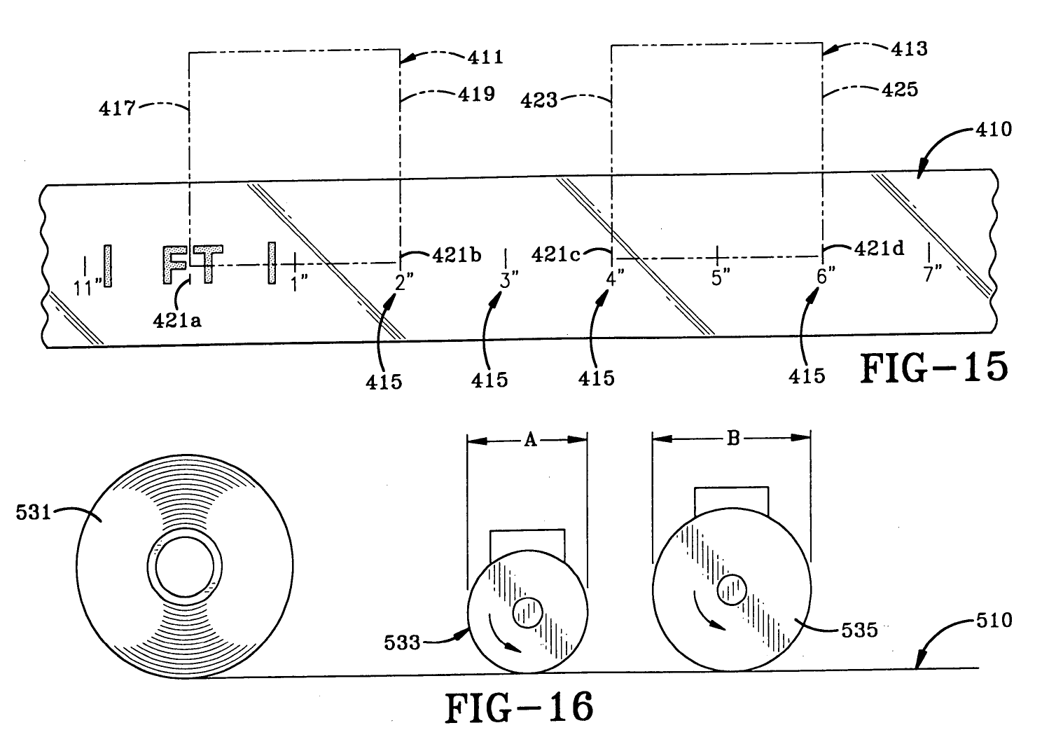

Referring to FIG. 15, construction tape in accordance with the present invention and generally indicated at 410 may be used to correctly position other types of construction members 411, 413. Tape 410 includes markers 415 which are spaced one inch apart. If the two construction members 411, 413 must be spaced two inches apart from each other then the sides of 417, 419 of member 411 are lined up with the markings 421a, 421b of markers 415. The sides 423, 425 of second member 413 are lined up with markings 421c, 421d of markers 415. Members 411 and 413 can then be secured in position by conventional means.

Referring to FIG. 16, there is shown a schematic drawing of how construction tape, generally indicated at 510 may be printed. A roll 531 of construction tape 510 is provided. Tape 510 is passed through print rollers 533, 535. First roller 533 has a first diameter “A” and the roller prints a first set of markers (not shown) onto tape 510. So, for example, first roller 533 may be used to mark one foot intervals along the length of tape 510. The circumference of the first roller is therefore one foot. The second roller 535 has a second diameter “B” and is used to mark a different interval along the length of tape 510. The second roller 535 may be used, for instance to mark intervals of 16 inches along the length of tape 510. First roller 533 applies a first color ink to tape 510 and second roller 535 applies a second and different color ink to tape 510. The intervals are applied substantially at the same time to the tape 510. It will be understood that one roller could be used to mark out more than just one interval. For example, first roller 535 could be used to mark both one foot and one inch intervals on tape 510. The intervals are marked on one of the upper and lower surfaces of the tape.

While the preferred embodiment of the construction measuring tape has been described above, it will be understood that various modifications may be made to the tape without departing from the spirit of the present invention. For instance, second markers 26 and first linear markers 36 may be placed proximate edges 40, 42 and third markers 30, along with second linear markers 38, may be positioned proximate midline X-X′. Furthermore, each of the first, second and third markers may be printed in a different color. Additionally, it will be understood that a paper backer may be applied to the lower surface 14 of tape 10 to cover the adhesive layer. The paper backer would be peeled from tape prior to application of the same on a construction member.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A construction measuring tape for indicating the correct placement of construction members, the measuring tape comprising:
an elongated tape having an upper surface, a lower surface with an adhesive applied thereto;
a plurality of indicia marked on one of the upper and lower surfaces of the tape; wherein the indicia include:
a plurality of repeating first markers marked at equal and repeating first intervals along the length of the tape;
a plurality of repeating second markers marked at equal and repeating second intervals along the length of the tape; wherein the second markers differ from the first markers and wherein the second intervals are longer than the first intervals;
a first linear marker disposed proximate each second marker; and
a plurality of third markers indicating equal and repeating third intervals along the length of the tape; wherein the third markers differ from the first and second markers and wherein the third intervals are longer than the first and the second intervals.

2. The construction measuring tape as defined in claim 1, wherein one of the first, second and third markers is marked in a first color and another of the first, second and third markers is marked in a second and different color.

3. The construction measuring tape as defined in claim 2, wherein the first linear markers are marked on the one of the upper and lower surfaces of the tape in the same color as the second markers.

4. The construction measuring tape as defined in claim 3; wherein the second linear markers are marked on the one of the upper and lower surfaces of the tape in the same color as the third markers.

5. The construction measuring tape as defined in claim 4, wherein a pair of first linear markers is disposed proximate each second marker.

6. The construction measuring tape as defined in claim 5, wherein each pair of first linear markers are separated from each other by a distance of between 1 and 2 inches.

7. The construction measuring tape as defined in claim 6, wherein each pair of first linear markers are separated from each other by a distance of 1½ inches.

8. The construction measuring tape as defined in claim 7, wherein a pair of second linear markers is disposed proximate each third marker.

9. The construction measuring tape as defined in claim 8, wherein each pair of second linear markers are separated from each other by a distance of between 1 and 2 inches.

10. The construction measuring tape as defined in claim 9, wherein each pair of second linear markers are separated from each other by a distance of 1½ inches.

11. The construction measuring tape as defined in claim 10, wherein the first markers comprise a line and a number.

12. The construction measuring tape as defined in claim 11, wherein the numbers of the first markers are sequentially selected from the group consisting of 1, 2, 3, 4, 5, 6, 7, 8, 9, 10 and 11.

13. The construction measuring tape as defined in claim 12, wherein the second markers are the letter “F”.

14. The construction measuring tape as defined in claim 13, wherein the third markers are the letter “S”.

15. The construction measuring tape as defined in claim 14, wherein the first interval is one inch long.

16. The construction measuring tape as defined in claim 15, wherein the second interval is one foot long.

17. The construction measuring tape as defined in claim 16, wherein the third interval is sixteen inches long.

18. The construction measuring tape as defined in claim 17, further comprising a plurality of perforations running along the length of the tape and adapted to separate the tape into two substantially equal segments each having the plurality of indicia marked thereon.

19. The construction measuring tape as defined in claim 1, wherein the tape is substantially transparent;

20. The construction measuring tape as defined in claim 19, further comprising a paper backer removably adhered to the lower surface of the tape.

21. A method of manufacturing a construction measuring tape including the steps of:
providing an elongated tape having an upper surface and a lower surface;
providing a first print roller having a first circumference;
providing a second print roller having a second circumference, wherein the first circumference of the first roller is smaller than the second circumference of the second roller;
passing the tape through the first roller, whereby a series of first indicia are marked on one of the upper and lower surfaces of the tape; and simultaneously
passing the tape through the second roller whereby a series of second indicia are marked on one of the upper and lower surfaces of the tape.

22. The method of manufacturing a construction tape as defined in claim 21, wherein the step of passing the tape through the first roller includes the step of providing the first roller with a first color ink and the step of passing the tape through the second roller includes the step of providing the second roller with a second color ink and the first ink is different in color to the second ink.
